(19) United States
(12) Patent Application Publication
(10) Pub. No.: US 2026/0312818 A1
(43) Pub. Date: Oct. 8, 2026

(54) INTELLIGENT CACHING OF STRUCTURED DOCUMENT ANALYSES

(71) Applicant: Cisco Technology, Inc., San Jose, CA (US)

(72) Inventors: Stève Sfartz, Carquefou (FR); Neelesh Pateriya, San Jose, CA (US); Daniel Tolbert, Raleigh, NC (US); Adrienne Joy Moherek, Austin, TX (US)

(73) Assignee: Cisco Technology, Inc., San Jose, CA (US)

(21) Appl. No.: 19/172,942

(22) Filed: Apr. 8, 2025

(51) Int. Cl. H04L 9/32

(52) U.S. Cl. CPC H04L 9/3236

(57) ABSTRACT

In one implementation, a device may hash contents of a structured document that describes an application programming interface. The device may compare a hash of the contents to cached hash values for contents of previously assessed structured documents to identify similarities. The device may apply a cached quality assessment metric for a previously assessed structured document demonstrating similarities. The device may assess (e.g., fully or partially) the structured document not demonstrating the similarities to generate an initial quality assessment metric.

### TECHNICAL FIELD

The present disclosure relates generally to intelligent caching of structured document analyses.

### BACKGROUND

Continuous Integration/Continuous Delivery (CI/CD) pipelines are a cornerstone of modern DevOps and exist to help automate software development workflows. Typically, with each change to a structured document in a CI/CD pipeline, such as program code, the system re-analyzes the entire document.

However, re-analyzing the full document in a CI/CD pipeline is a time and resource-consuming activity. Indeed, users are often left waiting on the order of minutes for the full analysis to complete. This is in spite of the fact that many document changes that trigger re-analysis do not affect the analysis results. For instance, a user making minor formatting changes to the document (e.g., adding or removing spaces, lines, etc.) may trigger full re-analysis of the document, only to return the same analysis results minutes later. Thus, this type of forced re-analysis can consume both the user's time as well as computing resources, unnecessarily.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of an architecture for structured document analysis;

FIG. 4 illustrates an example of a report out of the analysis of an API management platform;

FIG. 5 illustrates an example of a caching protocol that facilitates an intelligent reuse of past scoring results; and

FIG. 6 illustrates an example of a simplified procedure for intelligent caching of structured document analyses, in accordance with one or more implementations described herein.

### DESCRIPTION OF EXAMPLE IMPLEMENTATIONS

### Overview

According to one or more implementations of the disclosure, a device may hash the contents of a structured document (e.g., an OpenAPI document that describes an application programming interface (API) or any structured documents that follow formal specifications). The device may compare a hash of the contents to cached hash values for contents of previously assessed structured documents to identify similarities. The device may apply a cached quality assessment metric for a previously assessed structured document to a portion (e.g., all, less than all, etc.) of the contents of the structured document demonstrating the similarities. The device may assess a portion (e.g., all, less than all, etc.) of the contents of the structured document not demonstrating the similarities to generate an initial quality assessment metric.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

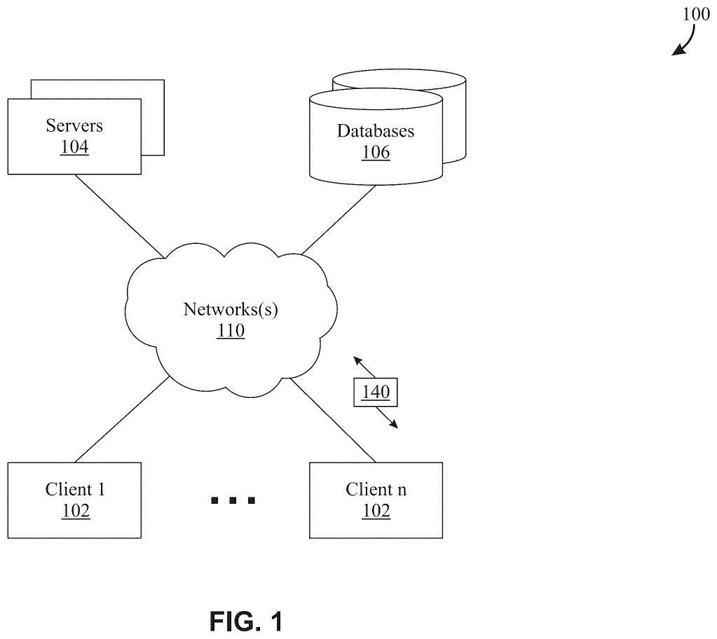

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

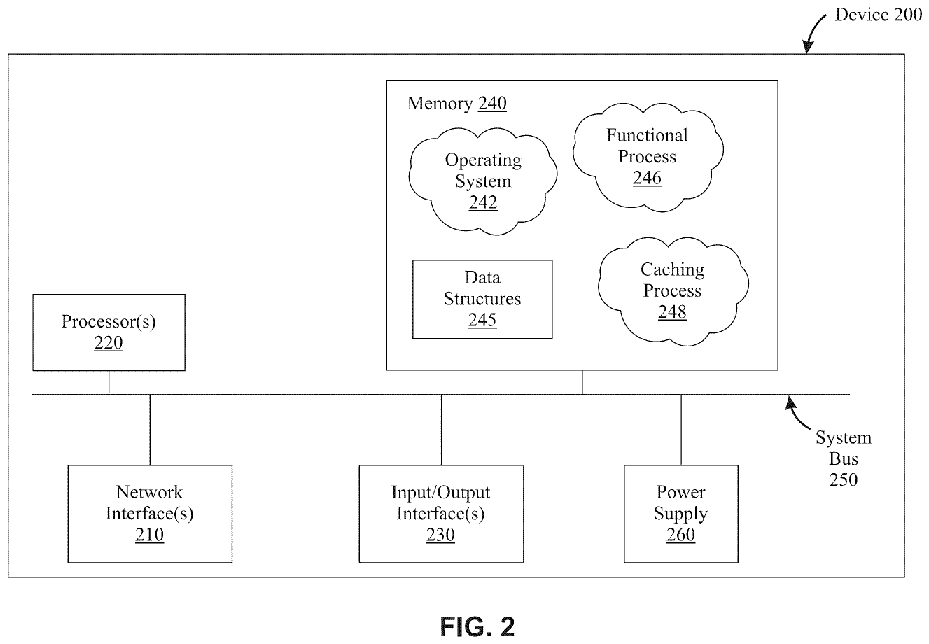

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes (e.g., functional processes 246), and on certain devices, a caching process 248, as described herein. Notably, functional processes 246, when executed by processor 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, caching process 248 may include computer executable instructions that, when executed by processor 220, cause device 200 to perform the techniques described herein. To do so, in some implementations, caching process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, caching process 248 may employ one or more supervised, unsupervised, or semi-supervised machine learning models. Generally, supervised learning entails the use of a training set of data that is used to train the model to apply labels to the input data. For example, the training data may include samples of structured document changes labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that caching process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, caching process 248 may also include, or otherwise use, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of intelligent caching of structured document analyses, caching process 248 may use a generative model to generate classifications of structured document modifications based on a conversational input from a user (e.g., voice, text, etc.). Example generative approaches can include, but are not limited to, generative adversarial networks (GANs), large language models (LLMs), other transformer models, and the like.

### Structured Document Analysis

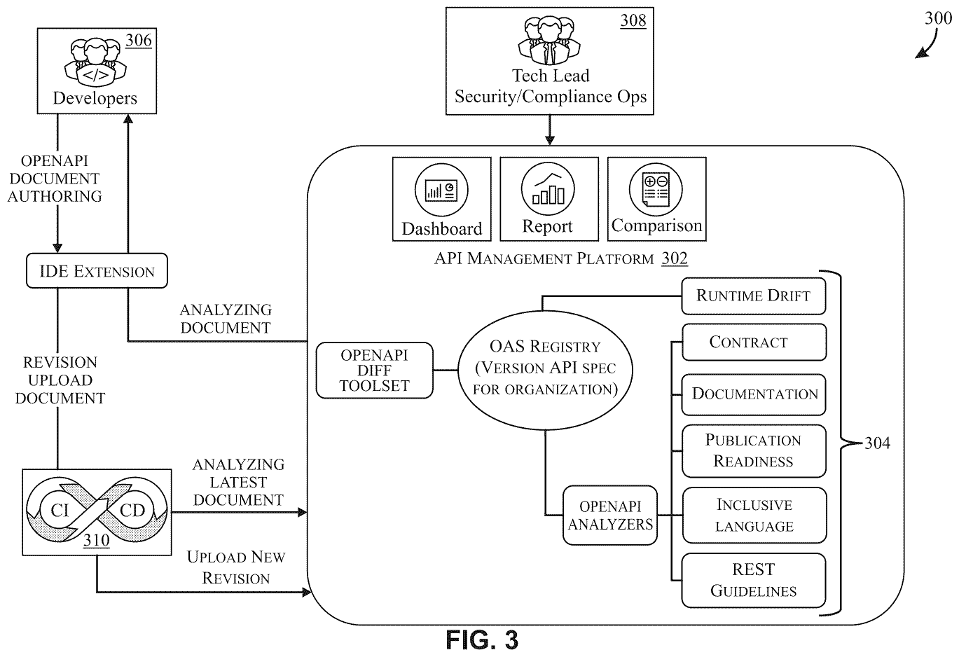

FIG. 3 illustrates an example of an architecture 300 for structured document analysis, in accordance with one or more implementations described herein. Architecture 300 may include an API management platform 302 (e.g., API insights, etc.). The API management platform 302 may include a centralized analysis service that performs static analysis on structured documents using delegated analyzers 304. Evaluation of the logic of the delegated analyzers may involve testing of attributes and specific requirements for the values of these attributes within the structured documents.

For example, each of the delegated analyzers 304 may evaluate a different aspect of an OpenAPI document (or any other structured document that adheres to a formal specification). For instance, a contract analyzer may be operable to assess a structured document for contract completeness such as each item having a defined schema. A documentation analyzer may be operable to assess a structured document for documentation completeness such as each item having a description. A publication readiness analyzer may be operable to assess the readiness to publish the document to a hub such as whether the document contains unsupported non-URL-safe characters for the in the operationId attribute. An inclusive language policy analyzer may be operable to scan the structured document for words listed in an inclusive language rule set definition. A design conventions analyzer may be operable to check if an API design conforms to established guidelines for the API.

The evaluation logic of the delegated analyzers 304 may generate results including characterizations and/or other findings that are based on the presence, absence, correctness, etc. of the attributes. The API management platform 302 may output these findings for consumption be developers 306 and/or tech lead security/compliance ops 308. In some instances, the API management platform 302 may provide reports that characterize changes to the structured and their impact on the stability, security, performance, compatibility, etc. of the corresponding API.

In addition, the API management platform 302 may flag and/or catalog various violations identified by the delegated analyzers 304. In addition, the API management platform 302 may include a code comparison or differentiating component to identify portions of the document that have been identified as findings by the delegated analyzers 304. These portions may be compared against prior versions so that issues may be identified and/or resolved before release. These and other insights may be provided via a user interface that facilitates visualization of the findings.

This functionality of the API management platform 302 may be automated and/or integrated with a CI/CD pipeline 310. This may provide and efficient and scalable mechanism to resolve issues early in the development cycle to improve API quality and apply the principle of shift left security. Moreover, developers 306 can leverage the API management platform 302 and/or its outputs to proactively resolve document-related and run-time issues within the integrated development environment (IDE). For example, API management platform 302 may be used to automatically assess and characterize changes to the structured document as they are input.

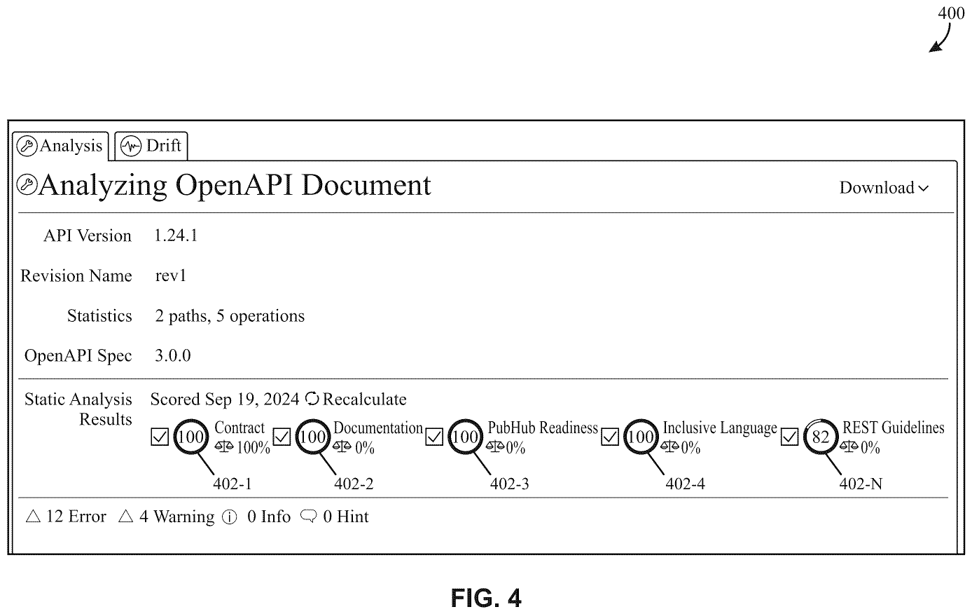

FIG. 4 illustrates an example of a report out 400 of the analysis of an API management platform (e.g., API management platform 302). The report out 400 may be based on the analysis by delegated analyzer components of the API management platform evaluating a modified structured document. The report out 400 may include characterizations 402 of the analysis by the API management platform.

In various implementations, the characterizations 402 may include scores or other indications of the results of the analysis. For instance, findings of the API management platform analysis may be used for scoring documents and comparing progress across revisions of documents. The score may be of any type, including a Boolean indicating if the analysis passed or not a defined threshold, or float comprised between 0 and 1 for the purpose of quality rating. In some instances, a characterization such as a score may be computed based on a severity of a rule and a total number of rules that did not pass under analysis by the delegated analyzers.

As noted above, the analysis of structured documents by an API management platform has an execution cost that is typically measured considering metrics such as total execution time and CPU consumption. For example, the evaluation of each rule by an analyzer consumes times and processing power to execute. Scoring logic can involve complex processing including expensive infrastructures such as AI. The execution cost of the static analysis conducted on documents may be a linear or exponential function when considering the size of the documents.

Presently, as structured documents evolve, analysis needs to be executed again for every revision. Along a CI pipeline, revisions are numerous. As a result, important resources are consumed while the actual analysis results may be similar across revisions.

There are multiple factors that would trigger a new analysis that could have otherwise been avoided. For example, when the formatting of the document has changed (spaces, newlines introduced, etc.), when minor changes happened (e.g., additional comments, etc.), when ordering of the structured document has changed (e.g., for formats where the ordering is not specified, automated generation of OpenAPI documents may generate a document that has the exact same contents but ordered differently, use of heterogeneous serializers/de-serializers would have side effects on ordering, etc.), when significant changes are made that have no actual impact to the analysis (e.g., attributes not considered in the analysis such as extensibility attributes in OpenAPI documents, or documentation updates not considered for contract analysis, etc.) a re-analysis of the full document may be triggered which is a time and resource-consuming activity that is largely unnecessary given that the actual analysis results may be similar across the revisions.

### Intelligent Caching of Structured Document Analyses

In contrast, the techniques described herein introduce intelligent caching of structured document analyses. This approach introduces a document similarity-based mechanism that categorizes types of changes in the context of analysis of structured documents and leverages a method to organize the caching of past analysis results. This allows for the optimization of the document analysis process, as only certain changes to a document trigger its re-analysis.

In particular, the techniques herein introduce a caching method that optimizes the reuse of past scoring results, considering a concept of ‘similarity’ applicable for structured documents. The concept of ‘similarity’ may be defined as structured documents that can be considered as equivalent when considering the computation results of a characterization analyzer. As such, API quality and security may be improved in an intelligent manner that conserves operational resources (e.g., time, money, computational resources, power resources, etc.).

Illustratively, the techniques described herein may be performed by hardware, software, and/or firmware, such as in accordance with caching process 248, which may include computer executable instructions executed by the processor 220 (or independent processor of interfaces 210) to perform functions relating to the techniques described herein.

Specifically, according to various implementations, a device may hash contents of a structured document such as an OpenAPI document that describes an application programming interface. The device may compare a hash of the contents to cached hash values for contents of previously assessed structured documents to identify similarities. The device may apply a cached quality assessment metric for a previously assessed structured document to a portion of the contents of the structured document demonstrating the similarities. The device may assess a portion of the contents of the structured document not demonstrating the similarities to generate an initial quality assessment metric for that portion.

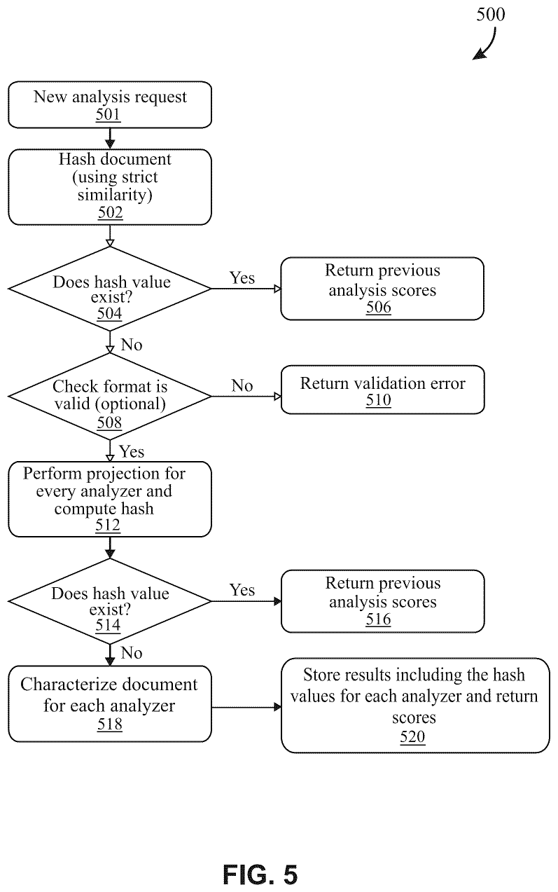

Operationally, FIG. 5 illustrates an example of a caching protocol 500 that facilitates an intelligent reuse of past scoring results, considering a concept of ‘similarity’ applicable for structured documents. The concept of ‘similarity’ may be defined as structured documents that can be considered as equivalent when considering the characterization of computation results by a structured document analyzer.

Multiple definitions of ‘similarity’ may be utilized in executing caching protocols. For example, a ‘strictly similar’ definition may be leveraged in caching protocol 500, which includes documents that are strictly identical (e.g., exactly the same when compared at the byte level, etc.). Further, a ‘structurally similar’ definition may be leveraged in caching protocol 500, which includes documents that are exactly similar when considering their specification format. Furthermore, a ‘functionally similar’ definition may be leveraged in caching protocol 500, which include documents that are similar when considering the attributes used by the analyzer (e.g., similar when considering the calculation operated by an algorithm of a scoring analyzer, etc.).

Multiple similarity approaches may be utilized to encompass the variety of scenarios considered when the documents may differ even though the analysis performed on the document would be similar. For example, leveraging multiple definitions of similarity may allow identification of scenarios involving formatting configuration of IDEs, operating systems native format transformation such as return carriage and newlines across linux and windows environment, little/big endian, and such, dynamic generation of documents from models or code using attributes tagging, encoding and decoding of documents when passing documents across software and network boundaries, CI toolchains that automatically generate the document such as merging of multiple documents or dereferencing/bundling, two different documents where the actual attributes used by the computation are similar (e.g., revisions of a document where contributors have different profiles and contribute to different parts of the document, such as an engineering working on the technical contract of an OpenAPI document while a technical writer is working on the documentation), etc.

Different caching methodologies may be applied with different document similarity approaches (e.g., ‘strict,’ ‘structural,’ ‘functional,’ etc.). For example, in a strictly similar document similarity approach where structured contents are exactly the same, a hashing (e.g., Sha256, etc.) of the full structured document contents may be undertaken. In a structurally similar document similarity approach where structured documents are similar when taking into consideration their specification format, ordering/sorting operations may be applied along with a sanitizer operation and/or byte hashing of the resulting document (alternatively, or additionally, a structural diff tooling (e.g., oasdiff, etc.) may be utilized to provide enhanced execution time and relevancy insights of the detected changes). In a functionally similar document similarity approach where structured documents are similar when taking into consideration the calculation operated by the algorithm of the corresponding scoring analyzer (e.g., scoring algorithm) ordering/sorting, a sanitizer operation, selective filtering of the attributes used by the scoring algorithm, and/or byte hashing of the resulting document may be applied.

More specifically, caching approaches may include an optional verification that the document conforms to a particular version of the ‘structured format’ specifications (e.g., this may be a safe assumption as scoring is not applicable if the document does not conform). A full ordering & formatting may be performed at the lower path level (e.g., considering the structured format is transformed to a machine interpretable format such as a hierarchical tree of components and subcomponents). A scoring projection may be applied, and a hash value may be created.

Intelligent caching may be performed by leveraging computed hash values and stores of the latest analysis results for a document with a similar hash. The intelligent caching techniques leverage the scoring projection being performed in a significantly faster elapsed time than the actual full scoring analysis. The larger the structured document gets, and the more analyzers that are offered by the centralized analysis engine, the more efficient the cache gets. Note that even smallest documents show benefits.

For example, intelligent caching may operate based on a projection of similar attributes. Projection may refer to the process of selecting and extracting a subset of elements, including their associated attributes and values, from a structured document. This process may include selectively extracting specific elements, along with their associated attributes and values, from a validly structured document.

This may allow for the creation of a subset of the original document based on predefined criteria, which may vary for each analyzer (e.g., the projection of attributes of the document may vary for every analyzer). The characterization of a subset may then be borrowed and/or based on a characterization of a similar set or subset of a cached structured document. Alternatively, or additionally, when there is not a characterized set or subset of a structured document in the cache sufficiently similar to a subset under analysis, then only the subset may be subjected to the full characterization (e.g., scoring regime).

In this manner, projecting may ensure that when scoring does not concern the entirety of the full structured document, only the parts that require characterization (e.g., portions dissimilar to scored portions in the cache) will undergo a full de novo characterization. Therefore, the operational resource expenditure associated with performing the characterizations for a structured document is limited to only those portions of the structure document that require characterization, while the other parts can have their characterizations inferred from similar portions of structured documents that were already analyzed, characterized (e.g., scored), and/or cached.

For example, a caching protocol 500 may be implemented (e.g., using components such as an analysis engine, an analyzer, a validator, a sorter, a projector for each analyzer to perform transformations and filtrations, a hash computation component, etc.) to perform intelligent structured document caching and characterizations that conserve operational resources by leveraging similarities to documents with known characterizations and limited as-needed new scoring. For instance, a new analysis request may be received at box 501. The request may include a request to analyze a structured document (e.g., OpenAPI document) to determine whether it complies with various quality requirements, compatibility requirements, functionality requirements, organizational standards, security requirements, etc. This may be a request in the form of a new or modified structured document being worked on and/or submitted to a tool such as API insights-Cisco internal centralized service for OpenAPI documents analysis. These structured documents may be ones being worked on and/or submitted via a CI/CD pipeline.

Caching protocol 500 may proceed to hash the structured document from the request (e.g., using strict similarity) at box 502. This may be a hashing of the full document contents. Then, a determination whether the hash value exists in a cache may be made at box 504. If this hash exists it may mean that a strictly similar structured document has previously been cached and/or characterized (e.g., scored with respect to the various quality requirements, compatibility requirements, functionality requirements, organizational standards, security requirements, etc.). Therefore, if there is a matching hash value found, the characterization (e.g., score) previously calculated, assigned to, and/or cached for that previously hashed matching structured document may be returned and/or assigned to the structured document and/or or structured document portion being analyzed at box 506.

Alternatively, if there is no matching hash found at box 504, then an optional check of whether the format of the document is valid may be performed at box 508. In instances where this optional check is performed and the formatting of the document in not valid then a validation error may be returned at box 510. If this optional check results in a determination that the format is valid (or if the format check is not performed), then caching protocol 500 may proceed to box 512 where a projection may be performed for each analyzer. This projection may include extracting subsets of specific elements, along with their associated attributes and values (e.g., where the subsets are those associated with the execution and/or operations of specific corresponding analyzers and/or are those subject to analysis and scoring by specific corresponding analyzers), from the structured document. The result may be a structured document that is logically segmented into subcomponents that correspond to analysis by corresponding distinct analyzers. Further, a corresponding hash may be computed for each of the projected subsets at box 512.

Then, at box 514, a determination may be made whether the hash values computed for the projections exist in the cache. If a matching hash exists in the cache, then it may mean that a similar structured document or similar portion of a structured document has previously been cached and/or characterized. Therefore, if there is a matching hash value found, then, at box 516, the stored characterization for that similar structured document or similar portion of a structured document may be returned and/or assigned to the structured document and/or or structured document portion being analyzed.

Alternatively, if, at box 514, there is not a matching hash found for a hash computed at box 512, then, at box 518, the structured document or portions of the structured document that do not have a matching hash for an analyzer may be characterized by this analyzer. At box 520, the results of the characterization may be stored for each analyzer such as findings and scores and the projected hash values for the purpose of re-use for future hash checks (e.g., box 514). As an optimization, when analysis does not concern the full document, then only the parts that still need to be scored may be scored and projected.

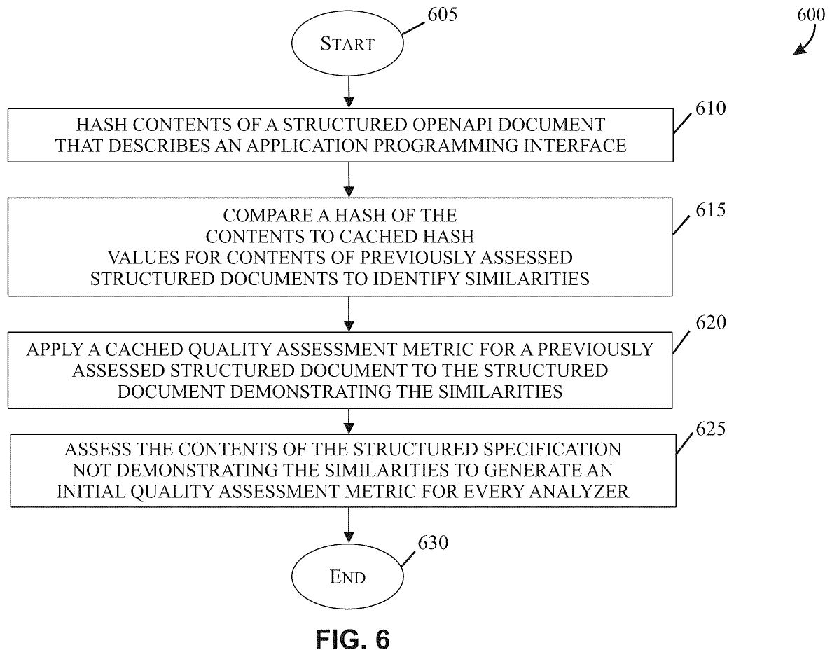

FIG. 6 illustrates an example of a simplified procedure for intelligent caching of structured document analyses, in accordance with one or more implementations described herein. For example, a non-generic, specifically configured device (e.g., device 200), may perform procedure 600 (e.g., a method) by executing stored instructions (e.g., caching process 248).

The procedure 600 may start at step 605, and continues to step 610, where, as described in greater detail above, the device (e.g., a controller, processor, etc.) may hash contents of a structured document. In various implementations, the structured document may be an OpenAPI document that describes an application programming interface. However, procedure 600 may be applicable to the analysis of any structured document that follows a formal specification. There are a variety of other API description formats that exist and would be applicable here too such as Protobuf, RAML, API blueprint, etc.

Hashing the contents of a structured document may include computing a sha256 hash of the structured document. This may occur responsive to creation and/or modification of the structured document in a continuous integration and continuous delivery process.

At step 615, as detailed above, a device may compare a hash of the contents to cached hash values for contents of previously assessed structured documents to identify similarities. The comparison may be utilized to identify various types of similarities among structured documents.

For example, the comparison may identify strictly similar structured documents (e.g., the documents are strictly identical, they are exactly the same when comparing at the byte level, etc.) by comparison of their hashes. Further, the comparison may identify structurally similar structured documents (e.g., the documents are exactly similar when considering the specifications format, etc.) by comparison of their hashes. Furthermore, the comparison may identify functionally similar structured documents (e.g., the documents are similar when considering the attributes used by an analyzer that generates quality assessment metrics, etc.) by comparison of their hashes.

In various implementations, the contents of the structured document of the application programming interface may be sorted and/or sanitized to create a resulting document. Then, the resulting document may be generated to generate the hash of the contents for comparison. In some instances, attributes of the contents of the structured document that describes the application programming interface utilized by a quality assessment algorithm may be selectively filtered and/or projected to create a resulting document. Then, the resulting document may be hashed to generate the hash of the contents for comparison.

At step 620, as detailed above, a device may apply a cached quality assessment metric for a previously assessed structured document to a portion of the contents of the structured document demonstrating the similarity when considering criteria of the analysis (e.g., ‘strict,’ ‘structural’, ‘functional,’ etc.). In this manner, the device may reuse past quality assessment metrics from similar structured documents rather than expending the operational resources to recalculate those metrics.

At step 625, as detailed above, the device may assess the contents of the structured document not demonstrating the similarities to generate an initial quality assessment metric for every applicable analyzer.

Optionally, the initial quality metric assessment metric may be generated based on an assessment of selectively extracted elements along with their associated attributes and values from the portion of the contents of the structured document not demonstrating the similarities.

Here, only a subset of the structured document may be assessed. That is, when scoring does not concern the full document, then only the parts needed to score the structured document may be projected and/or assessed. Assessing the structured document and/or generating quality assessment metrics (e.g., using scoring logic) may involve complex processing involving expensive infrastructures such as AI. As such, avoidance or rescoring may represent a significant conservation of operational resources.

The initial quality assessment may then be cached for use in future hash comparisons. Therefore, when a structured document is obtained in the future that exhibits similarities to the one that was assessed and characterized, then the initial quality assessment (now cached) can be applied to that future structured document.

In various implementations, the cached quality assessment metric and/or the initial quality assessment metric may be provided as feedback on modifications made to the application programming interface during the continuous integration and continuous delivery process. These metrics may serve as characterizations of a corresponding API's stability, security, performance, compatibility, etc.

At any point, a structural differentiator may be used to identify differences between the structured document of the application programming interface and a corresponding previously assessed structured document. The structural differentiator may highlight meaningful and/or useful differences between documents. This may include highlighting functional changes while ignoring insignificant formatting or metadata changes. The structural differentiator may operate instead of or on top of the hash comparison technique to further inform API developers of consequential differences between versions and/or documents.

Procedure 600 then ends at step 630.

It should be noted that while certain steps within procedure 600 may be optional as described above, the steps shown are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce intelligent caching of structured document analyses. These techniques facilitate leveraging previously computed quality assessment metrics to enhance the efficiency and scalability of structured document analysis. By identifying similarities or equivalencies between structured documents, the system can retrieve and apply cached assessment metrics rather than recalculating them from scratch, thereby reducing computational overhead and improving processing speed. This allows for real time validation and governance of structured documents within automated development workflows without unnecessary redundancy.

For example, when a new structured document is introduced that shares substantial structural, functional, or semantic equivalency with the previously analyzed documents-such as an updated API definition with minor modifications-the system can reuse relevant portions of the existing quality assessment metrics, ensuring consistent validation without redundant processing. This capability is particularly valuable in CI/CD pipelines, where rapid iteration and continuous compliance checks are critical. The system ensures that structure documents are efficiently analyzed without compromising accuracy, enabling automated governance at scale.

Furthermore, by leveraging cached structured documents and/or associated quality assessments, the system facilitates automated impact analysis, allowing teams to maintain compliance with established guidelines while reducing unnecessary computational costs. Additionally, structured documents processed through this method can be more effectively monitored over time, allowing organizations to track compliance trends, enforce evolving standards, and detect deviations in API behavior.

By introducing a mechanism for intelligently reusing prior assessment data, these techniques provide an efficient, scalable, and consistent approach to structured document analysis. This allows for streamlined automation in API governance, ensuring that quality, security, and compliance checks are seamlessly integrated into modern software development pipelines.

While there have been shown and described illustrative implementations that provide for intelligent caching of structured document analyses, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
hashing, by a device, contents of a structured document that describes an application programming interface;
comparing, by the device, a hash of the contents to cached hash values for contents of previously assessed structured documents to identify similarities;
applying, by the device, a cached quality assessment metric for a previously assessed structured document to a portion of contents of the structured document that demonstrate similarities when considering a criteria of analysis; and
assessing, by the device, contents of the structured document for all criteria considered for analysis to generate initial quality assessment metrics.

2. The method as in claim 1, further comprising:
caching the initial quality assessment metrics for use in future hash comparisons.

3. The method as in claim 1, further comprising:
providing at least one of the cached quality assessment metric or the initial quality assessment metrics as feedback on modifications made to the application programming interface during a continuous integration and continuous delivery process.

4. The method as in claim 1, wherein the initial quality assessment metrics are generated based on an assessment of selectively extracted elements along with their associated attributes and values from the portion of the contents of the structured document not demonstrating the similarities.

5. The method as in claim 1, further comprising:
sorting and sanitizing the contents of the structured document of the application programming interface to create a resulting document; and
hashing the resulting document to generate the hash of the contents for comparison.

6. The method as in claim 5, wherein the similarities are structural similarities when considering a specifications format of the structured document.

7. The method as in claim 1, further comprising:
selectively filtering attributes of the contents of the structured document of the application programming interface utilized by a quality assessment algorithm to create a resulting document; and
hashing the resulting document to generate the hash of the contents for comparison.

8. The method as in claim 7, wherein the similarities are functional similarities when considering a calculation operated by an analyzer that generates quality assessment metrics.

9. The method as in claim 1, further comprising:
utilizing a structural differentiator to identify differences between the structured document of the application programming interface and a corresponding previously assessed structured specification.

10. The method as in claim 1, wherein only a subset of the structured document that is associated with scoring the structured document of the application programming interface is assessed.

11. An apparatus, comprising:
one or more network interfaces;
a processor coupled to the one or more network interfaces and configured to execute one or more processes; and
a memory configured to store a process that is executable by the processor, the process when executed configured to:
hash contents of a structured document that describes an application programming interface;
compare a hash of the contents to cached hash values for contents of previously assessed structured documents to identify similarities;
apply a cached quality assessment metric for a previously assessed structured document to a portion of the contents of the structured document demonstrating the similarities; and
assess a portion of the contents of the structured document not demonstrating the similarities to generate an initial quality assessment metric for that portion.

12. The apparatus as in claim 11, wherein the process when executed is further configured to:
cache the initial quality assessment metric for use in future hash comparisons.

13. The apparatus as in claim 11, wherein the process when executed is further configured to:
provide at least one of the cached quality assessment metric or the initial quality assessment metric as feedback on modifications made to the application programming interface during a continuous integration and continuous delivery process.

14. The apparatus as in claim 11, wherein the portion of the contents of the structured document not demonstrating the similarities is assessed to generate an initial quality assessment metric for each corresponding analyzer.

15. The apparatus as in claim 11, wherein the process when executed is further configured to:
sort and sanitize the contents of the structured document describing the application programming interface to create a resulting document; and
hash the resulting document to generate the hash of the contents for comparison.

16. The apparatus as in claim 15, wherein the similarities are structural similarities when considering a specifications format of the structured document.

17. The apparatus as in claim 11, wherein the process when executed is further configured to:
selectively filter attributes of the contents of the structured document of the application programming interface utilized by a quality assessment algorithm to create a resulting document; and
hash the resulting document to generate the hash of the contents for comparison.

18. The apparatus as in claim 17, wherein the similarities are functional similarities when considering a calculation operated by an analyzer that generates quality assessment metrics.

19. The apparatus as in claim 11, wherein the process when executed is further configured to:
utilize a structural differentiator to identify differences between the structured document of the application programming interface and a corresponding previously assessed structured document.

20. A tangible, non-transitory, computer-readable medium storing program instructions that cause a device to execute a process comprising:
hashing contents of a structured document that describes an application programming interface;
comparing a hash of the contents to cached hash values for contents of previously assessed structured documents to identify similarities;
applying a cached quality assessment metric for a previously assessed structured document to a portion of the contents of the structured document demonstrating the similarities; and
assessing, when applicable for a corresponding analyzer, contents of the structured document not demonstrating the similarities to generate an initial quality assessment metric for each analyzer.
